(19) United States
(12) Patent Application Publication
(10) Pub. No.: US 2007/0153724 A1
(43) Pub. Date: Jul. 5, 2007

(54) Apparatus and method for enhancing link performance of multicast service in wireless system

(75) Inventors: Jung-Hoon Cheon, Suwon-si (KR); Sung-Hyun Cho, Suwon-si (KR); Dong-Ho Cho, Seoul (KR); Tae-Soo Kwon, Ansan-si (KR); Ju-Yeop Kim, Anyang-si (KR); Ho-Won Lee, Chungju-si (KR); O-Hyun Jo, Cheongju-si (KR); Sik Choi, Yuseong-gu (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Korea Advanced Institute of Science and Technology, Yuseong-gu (KR)

(21) Appl. No.: 11/649,027

(22) Filed: Jan. 3, 2007

(30) Foreign Application Priority Data
Jan. 3, 2006 (KR) 10-2006-0000338

(51) Int. Cl. H04Q 7/00

(52) U.S. Cl. 370/328

(57) ABSTRACT

Provided is an apparatus and method for enhancing the link performance of a multicast service for UEs in a wireless system. In the method, multicast data received in an Nth frame is recovered using systematic packets. When the recovery fails, parity packets are received in an (N+1)th frame and are used to recover the multicast data. When the recovery fails again, an autonomous handover is performed to receive parity packets from a neighboring cell or sector, which are used to recover and the multicast data.

### PRIORITY

This application claims priority under 35 U.S.C. § 119 to an application filed in the Korean Intellectual Property Office on Jan. 3, 2006 and allocated Serial No. 2006-338, the contents of which are incorporated herein by reference.

### BACKGROUND OF THE INVENTION

1. Field of the Invention

The present invention relates generally to a wireless system, and in particular, to an apparatus and method for enhancing the link performance of a multicast service in a wireless system.

2. Description of the Related Art

With the increasing development of communication technologies, mobile communication service has evolved from the conventional voice communication service to a packet communication service capable of transmitting a large amount of voice, packet and circuit data, and a multimedia broadcast/communication service capable of transmitting multimedia data. Recently, a Multimedia Broadcast/Multicast Service (MBMS) system has been developed to support the multimedia broadcast/communication service.

In the MBMS system, the same multimedia data is multicast from one or more data sources to a plurality of User Equipments (UEs) through a radio network. The MBMS system can save radio transmission resources because a plurality of UEs share one radio channel. The MBMS system supports transmission of various multimedia data such as real-time video and audio data, still images and text, and simultaneously transmits video and audio data, thus requiring a large amount of transmission resources.

The MBMS system can be applied to 3rd Generation Partnership Project (3GPP) that is the standard of a 3G asynchronous mobile communication network. In order to multicast the same data to a plurality of cells in which a plurality of UEs are located, the MBMS system uses a Point-to-Point (PtP) transmission scheme or a Point-to-Multipoint (PtM) transmission scheme depending on the number of UEs located in each cell. The PtP transmission scheme allocates a dedicated channel to each UE, thereby providing a desired MBMS service to each UE. The PtM transmission scheme allocates a common channel to a plurality of UEs requesting a specific MBMS service, thereby providing the specific MBMS service to the UEs simultaneously.

The PtM transmission scheme uses logical channels such as an MBMS Traffic Channel (MTCH) for transmitting MBMS data and an MBMS Control Channel (MCCH) for transmitting control information necessary for reception of the MBMS data. These logical channels correspond to a Forward Access Channel (FACH) that is a transport channel, and are transmitted to UEs requesting the MBMS over the Secondary Common Control Physical Channel (S-CCPCH). One cell is allocated only one MCCH. Examples of the control information are start and end information of MBMS data transmission, a physical channel, a transport channel, and a logical channel for MBMS data transmission, and information about neighboring cells supporting the same MBMS service and MBMS services provided to a current cell. Using information about the MCCH, a UE can perform a handover to a new cell to rapidly receive MBMS data from the new cell.

However, the PtM transmission scheme adjusts a Modulation and Coding Scheme (MCS) level to the worst channel environment of UEs in a multicast group. The use of such a low MCS level causes performance degradation, and even UEs with good channel environments receive MBMS data at a low MCS level for a long time. In general, UEs with poor channel environments correspond to UEs that are located in a cell boundary region with high interference. There is a method in which MBMS data is transmitted at the medium MCS level instead of the lowest MCS level, and is retransmitted at the lowest MCS level when a UE fails to receive the MBMS data within a predetermined time and then transmits a feedback for requesting the retransmission over a reverse link (RL) feedback channel. This method, however, may cause the problem of providing a broadcast service during the retransmission operation, and may also cause a waste of time in comparison with a method of transmitting MBMS data at the lowest MCS level from the transmission outset.

The 3rd Generation Partnership Project 2 (3GPP2) proposes a Broadcast Multicast Service (BCMCS) to provide a broadcast service without the RL feedback channel. In a traffic state, the BCMCS uses a forward link (FL) dedicated channel for the PtP transmission and a Forward-Supplemental Channel (F-SCH) for the PtM transmission, allowing a plurality of UEs to receive the F-SCH.

For channel coding, the BCMCS may use an inner coding scheme such as a convolutional or a turbo coding scheme and may also use a well-known error correction outer coding scheme such as the Reed-Solomon (RS) coding scheme. The use of the RS coding scheme can prevent consecutive transmission errors of broadcast data. That is, the BCMCS can enhance the Transmission (TX) power efficiency by correction of errors through the outer coding scheme, even without consideration of power control. However, a UE merely receives multicast data over the F-SCH and doest not transmit RL feedback information because there is no separate RL channel. Therefore, a base station (BS) can only transmit data at the lowest MCS level in accordance with the channel conditions of UEs in a cell boundary region.

As described above, the downlink broadcast service can only transmit data in compliance with the UE having the worst channel condition. In order to solve such a serious interference between UEs, there has been proposed a simulcast environment in which all the cells in an Orthogonal Frequency Division Multiplexing (OFDM) system transmit the same data at the same time point. In a conventional cellular environment using a unicast scheme, the interference must consider influences from cells in a wide region. However, when the same content is transmitted in the simulcast scheme from cells in a wide region, an interference-free thermal-noise environment can be implemented, which substantially enhances the broadcast performance.

The simulcast scheme can solve the performance degradation due to the cell boundary UEs and is suitable for a central broadcast service targeting a wide area. However, the simulcast scheme is unsuitable for a regional broadcast service because a problem may occur in a boundary zone between broadcast regions. In particular, the simulcast scheme is unsuitable for a broadcast or multicast service that provides information such as traffic and weather for a specific service area. In addition, the simulcast scheme requires investment costs because frequency-domain or time-domain resources must be additionally allocated for a simulcast service. Moreover, the simulcast scheme requires a sufficient length of cyclic prefix because a UE must simultaneously receive the same signal waveform from a plurality of cells.

### SUMMARY OF THE INVENTION

An object of the present invention is to substantially solve at least the above problems and/or disadvantages and to provide at least the advantages below. Accordingly, an object of the present invention is to provide an apparatus and method for enhancing the link performance of a multicast service in a wireless system.

Another object of the present invention is to provide an apparatus and method for enhancing the link-level performance of a multicast service by transmission of the same multicast packet between cells in a wireless system that supports an autonomous handover.

A further object of the present invention is to provide an apparatus and method for increasing opportunities for reception of retransmission packets by cell boundary UEs requesting a multicast service in a wireless system that supports an autonomous handover, thereby enhancing the link-level performance of the cell boundary UEs and the total cell throughput.

According to the present invention, there is provided a method for enhancing the link performance of a multicast service for UEs in a wireless system, the method including recovering, when multicast data is received in an Nth frame, the multicast data by use of systematic packets of the multicast data, receiving, when the recovery of the multicast data fails, parity packets of the multicast data in an (N+1)th frame and recovering the multicast data by use of the received parity packets, and receiving, when the recovery of the multicast data fails again, parity packets of the multicast data from a neighboring cell or sector by performance of an autonomous handover and recovering the multicast data by use of the parity packets received from the neighboring cell or sector.

According to the present invention, there is provided a method for enhancing the link performance of a multicast service of a BS in a wireless system, the method including generating, if there is multicast data to be transmitted at a current frame, systematic blocks and parity blocks by use of an outer coding scheme and buffering the generated parity blocks for a time period, and transmitting generated systematic blocks and a parity block of previous multicast data that is created in a previous frame and buffered for a previous time period.

According to the present invention, there is provided a transmitter for enhancing the link performance of a multicast service of a BS in a wireless system, the transmitter including an outer encoder for encoding multicast data by an outer coding scheme to output the resulting encoded blocks including systematic blocks and parity blocks, a parity block transmission controller for controlling the times to transmit the parity blocks from BSs such that the parity blocks are transmitted from sectors or cells at different time points, and a parity block buffer for buffering the parity blocks from the outer encoder for a time period and outputting the buffered parity blocks under the control of the parity block transmission controller.

According to the present invention, there is provided a receiver for enhancing the link performance of a multicast service for UEs in a wireless system, the receiver including an outer decoder for decoding an input packet by an outer decoding scheme to output the resulting decoded packet, an error detector for detecting whether the decoded packet has an error to output the error detection results, a cell/sector selector for determining whether to perform an autonomous handover based on the error detection results, and a handover controller for selectively performing the autonomous handover according to the determination results.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a transmitter of a BS in a wireless system according to the present invention;

FIG. 2 is a block diagram of a receiver of a UE in a wireless system according to the present invention;

FIG. 3 is a diagram illustrating an RX coding scheme according to the present invention;

FIG. 4 is a flowchart illustrating a procedure for transmitting multicast data from a BS in a wireless system according to the present invention;

FIG. 5 is a flowchart illustrating a procedure for receiving multicast data at a UE in a wireless system according to the present invention;

FIG. 6 is a diagram illustrating a method for transmitting RS-encoded packets in a wireless system according to first and second embodiments of the present invention;

FIG. 7 is a diagram illustrating a method for transmitting RS-encoded packets in a wireless system according to a third embodiment of the present invention; and

FIG. 8 is a graph illustrating the simulation results that compare the cell throughput of the conventional system with the cell throughputs of the systems according the first, second and third embodiments.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention provides an apparatus and method for enhancing the link performance of a multicast service in a wireless system that supports a unicast service and uses an outer coding scheme to support a multimedia broadcast/multicast service.

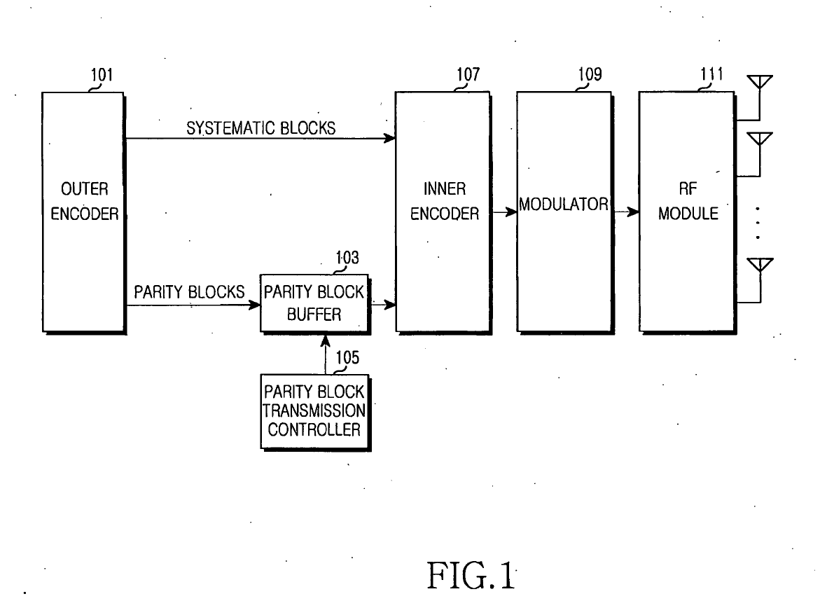

FIG. 1 is a block diagram of a transmitter of a BS in a wireless system according to the present invention.

Referring to FIG. 1, the transmitter includes an outer encoder 101, a parity block buffer 103, a parity block transmission controller 105, an inner encoder 107, a modulator 109 and a Radio Frequency (RF) module 111.

The outer encoder 101 encodes an input multicast data packet by an outer coding scheme to output the resulting encoded blocks. The encoded blocks include systematic blocks and parity blocks. The outer encoder 101 outputs the systematic blocks and the parity blocks to the inner encoder 107 and the parity block buffer 103, respectively. The systematic block includes traffic data to be transmitted. The parity block includes error correction data that is added to correct transmission errors during a decoding operation of a corresponding receiver, and contains information about the corresponding systematic block. Therefore, when the systematic blocks have an error, they can be recovered solely by the parity blocks. For example, the outer coding scheme may be an RS coding scheme.

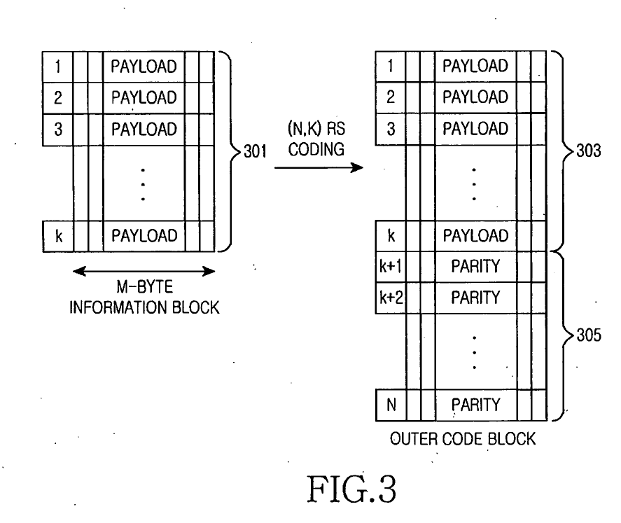

FIG. 3 illustrates the RX coding scheme according to the present invention. Referring to FIG. 3, in an (N, K) RS coding scheme, K number of payload packets 301 are encoded into K number of systematic packets (i.e., payload packets 303) and (N-K) number of parity packets 305. A corresponding UE, which has received the encoded packets, can recover information blocks for multicast data if it succeeds in recovering only K number of the packets among N number of the payload/parity packets 303 and 305.

The parity block buffer 103 serves as a module that enables BSs of different cells or sectors to transmit parity bits at different times. To this end, the parity block buffer 103 buffers the parity blocks received from the outer encoder 101 and outputs the buffered parity blocks to the inner encoder 107 under the control of the parity block transmission controller 105. The parity block transmission controller 105 controls the times to transmit parity bits from BSs of different cells or sectors such that the BSs transmits the parity bits at different times.

The inner encoder 107 encodes the systematic blocks from the outer encoder 101 and the buffered parity blocks from the parity block buffer 103 by an inner coding scheme, and outputs the encoded blocks to the modulator 109. Examples of the inner coding scheme are a turbo coding scheme and a convolutional coding scheme.

The modulator 109 modulates the encoded transmission data by a modulation scheme to generate transmission symbols. The RF module 111 processes the generated transmission symbols into RF signals and transmits the RF signals through a TX antennal over the air.

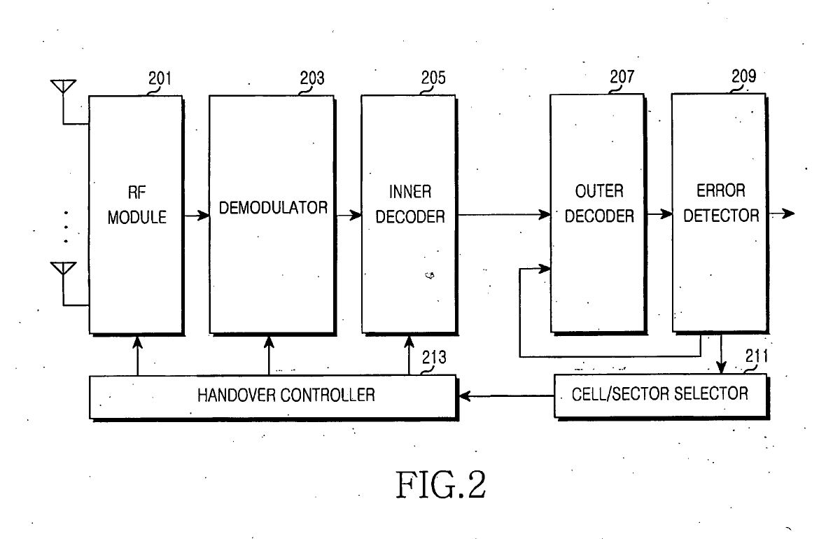

FIG. 2 is a block diagram of a receiver of a UE in a wireless system according to the present invention.

Referring to FIG. 2, the receiver includes an RF module 201, a demodulator 203, an inner decoder 205, an outer decoder 207, an error detector 209, a cell/sector selector 211 and a handover controller 213.

The RF module 201 receives RF signals through a reception (RX) antenna and outputs the RF signals to the demodulator 203. The demodulator 203 Orthogonal Frequency Division Multiplexing/Code Division Multiplexing (OFDM/CDM)-demodulates the RF signals to output the demodulated signals to the inner decoder 205. The inner decoder 205 decodes the demodulated signals by an inner decoding scheme to output the decoded signals to the outer decoder 207. Examples of the inner decoding scheme are a turbo decoding scheme and a convolutional decoding scheme.

The outer decoder 207 decodes the output signals of the inner decoder 205 by an outer decoding scheme such as the RS decoding scheme, to output the resulting decoded blocks to the error detector 209. The error detector 209 detects whether the decoded blocks from the outer decoder 207 have a packet error, and outputs the error detection results to the cell/sector selector 211 and the outer decoder 207. At this point, the outer decoder 207 again performs an outer decoding operation using the erroneous packet, a parity packet received in the next frame, and/or a parity packet received by an autonomous handover.

The cell/sector selector 211 determines whether to perform an autonomous handover based on the error detection results received from the error detector 209. The handover controller 213 selectively performs an autonomous handover according to the determination results. That is, when a determination is made to perform an autonomous handover, the handover controller 213 performs the autonomous handover by controlling the RF module 201, the demodulator 203 and the inner decoder 205.

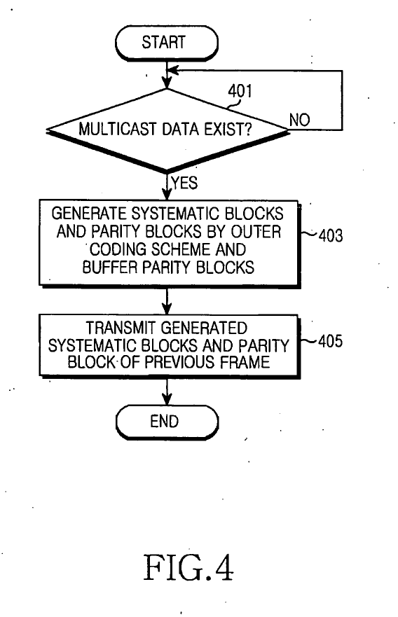

FIG. 4 is a flowchart illustrating a procedure for transmitting multicast data from a BS in a wireless system according to the present invention.

Referring to FIG. 4, the BS detects in step 401 whether there is multicast data to be transmitted in a current frame. If so, the procedure proceeds to step 403, and if not, the procedure repeats step 401. In step 403, the BS generates systematic blocks and parity blocks by an outer coding scheme, such as an (N, K) RS coding scheme, and buffers the generated parity blocks for a time period.

In step 405, the BS transmits the systematic blocks and a parity block of the previous multicast data that is generated in the previous frame and buffered for a previous time period. At this point, the serving/neighboring cells or sectors of the BS transmit parity blocks at different times. For example, if a BS of a α-type sector or cell transmits parity blocks for a frame A in the first frame, a BS of a β-type sector or cell transmits the parity blocks for the frame A in the second frame. Thereafter, the BS ends the procedure.

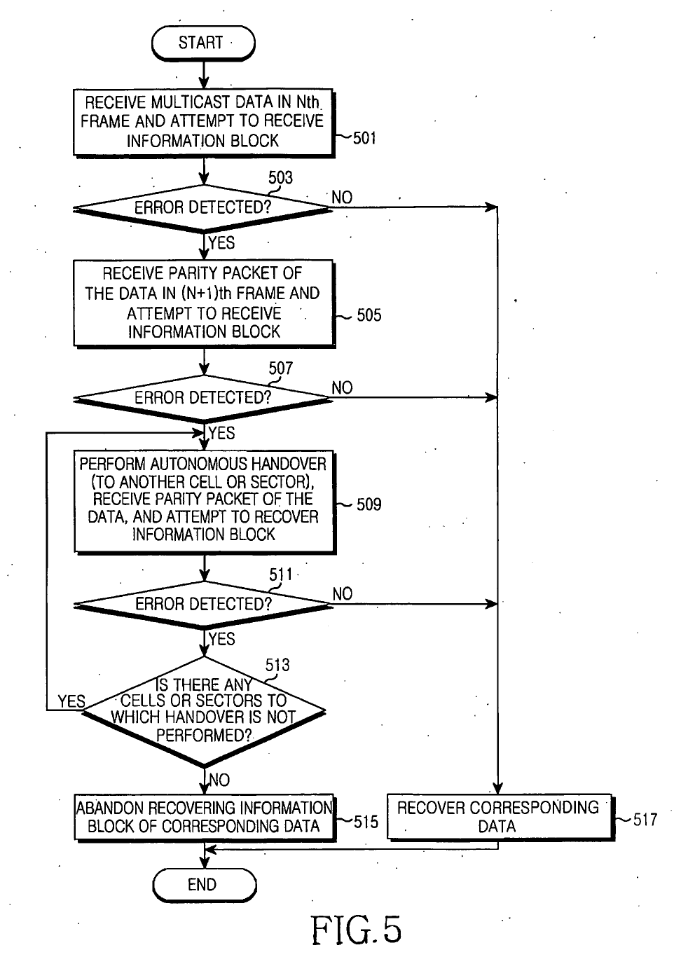

FIG. 5 is a flowchart illustrating a procedure for receiving multicast data at a UE in a wireless system according to the present invention.

Referring to FIG. 5, the UE receives multicast data in the Nth frame and attempts to recover an information block using the received multicast data in step 501. The received multicast data includes a systematic block for the Nth frame and a parity block for the previous frame.

In step 503, the UE determines whether an error is detected during the recovering operation. If so, the procedure proceeds to step 505, and if not, the procedure proceeds to step 517. In step 505, the UE receives a parity packet for the data of the Nth frame in the (N+1)th frame and attempts to recover the information block using the received parity packet.

In step 507, the UE determines whether an error is detected during the recovering operation. If so, the procedure proceeds to step 509, and if not, the procedure proceeds to step 517. In step 509, the UE performs an autonomous handover to a neighboring cell or sector, receives a parity packet for the data of the Nth frame in the next frame, and attempts to recover the information block using the received parity packet.

In step 511, the UE determines whether an error is detected during the recovering operation. If so, the procedure proceeds to step 513, and if not, the procedure proceeds to step 517. In step 517, the UE recovers the corresponding data. Thereafter, the UE ends the procedure.

In step 513, the UE determines whether there are any cells or sectors to which a handover is not performed. If not, the procedure proceeds to step 515, and if so, the procedure returns to step 509. In step 509, the UE performs an autonomous handover to another cell or sector, receives a parity packet for the data of the Nth frame in the next frame, and attempts to recover an information block using the received parity packet.

In step 515, the UE abandons receiving the corresponding packet. Thereafter, the UE ends the procedure.

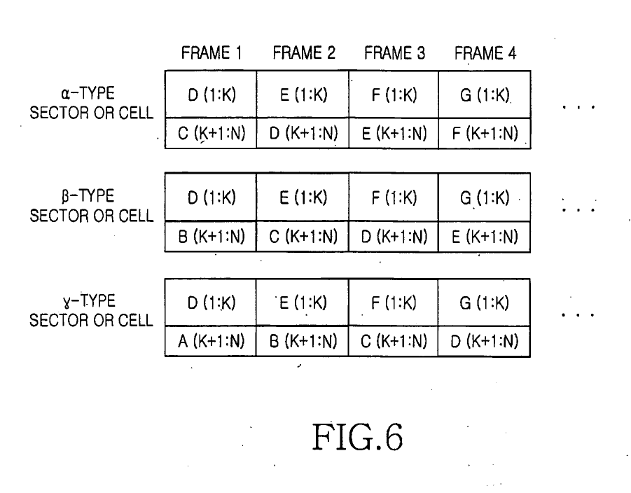

FIG. 6 is a diagram illustrating a method for transmitting RS-encoded packets in a wireless system according to first and second embodiments of the present invention.

Referring to FIG. 6, a BS broadcasts payload packets (i.e., 1˜K systematic packets) among (N, K) RS-encoded packets from respective sectors or cells simultaneously in a corresponding frame in order to satisfy service delay requirements. Conversely, the BS broadcasts (K+1)˜N parity packets among the (N, K) RS-encoded packets from the respective sectors or cells at different times. At this point, a UE considers parity packets received by an autonomous handover solely by using repeated packets.

For example, when one cell includes three types of sectors (i.e., an α-type sector, a β-type sector and a γ-type sector), the α, βand γ-type sectors receive a systematic packet D in the first frame and receive a systematic packet E in the second frame. Likewise, the α, βand γ-type sectors receive the subsequent systematic packets F and G in the third and fourth frames. At this point, the respective sectors transmit the systematic packets in the current frame, along with different parity packets for the previous frame. That is, in the first frame, the α-type sector receives the systematic packet D and a parity packet C of the previous frame, the β-type sector receives the systematic packet D and a parity packet B of the previous frame, and the γ-type sector receives the systematic packet D and a parity packet A of the previous frame.

In the second frame, the α-type sector receives the systematic packet E and a parity packet D of the previous frame, the β-type sector receives the systematic packet E and a parity packet C of the previous frame, and the γ-type sector receives the systematic packet E and a parity packet B of the previous frame.

If an information block cannot be recovered from the systematic packet D received in the first frame, a UE receiving a service from the α-type sector attempts to recover the information block using the parity packet D that is transmitted along with the systematic packet E in the second packet.

Also, if the information block cannot be recovered from the parity packet D received in the second frame, the UE performs an autonomous handover from the α-type sector to the β-type sector and again receives the parity packet D from the β-type sector in the third frame. In addition, if the information block cannot be recovered from the parity packet D received from the β-type sector, the UE performs an autonomous handover from the β-type sector to the γ-type sector and again receives the parity packet D from the γ-type sector in the fourth frame. Moreover, if the information block cannot be recovered for all the handovers, the UE may discard the corresponding packet.

As described above, the UE repeatedly receives the parity packet, thereby causing a reduction in the error probability of the parity packet and the information block. Moreover, when considering only downlink reception, it is possible to sufficiently reduce a delay that is caused by a handover. During the delay due to the autonomous handover, the wireless system provides the link information of the neighboring sector or cell and the resource allocation information about the parity packet over the 3GPP MCCH.

In the second embodiment of the present invention, a chase-combining operation is performed on the parity blocks that are received by the autonomous handover. In this case, when the number of the (N, K) RS-encoded (N-K) parity blocks increases, the error probability of the parity blocks decreases and the data recovery probability increases, which enhances the system performance.

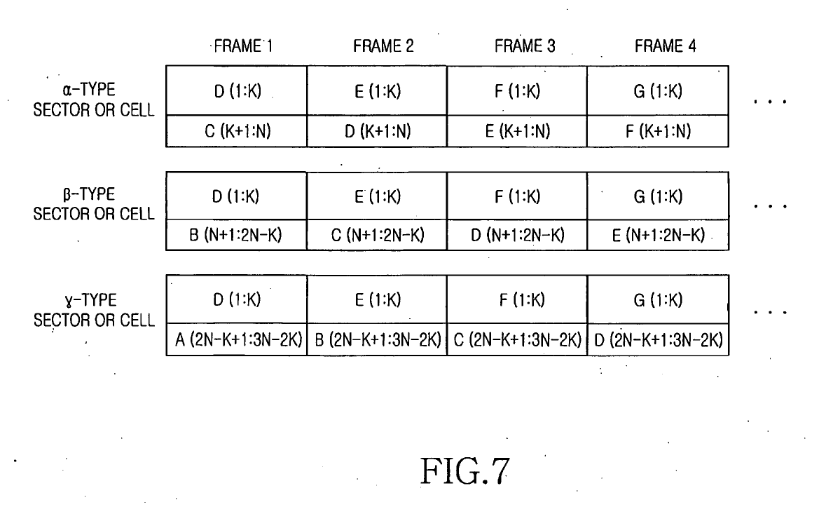

FIG. 7 is a diagram illustrating a method for transmitting RS-encoded packets in a wireless system according to a third embodiment of the present invention.

Referring to FIG. 7, a BS encodes (3N−2K, K) RS multicast packets and transmits the (3N−2K, K) RS-encoded packets. At this point, the BS simultaneously transmits payload packets (i.e., 1˜K systematic packets) among the (3N−2K, K) RS-encoded packets from respective sectors or cells in a corresponding frame in order to satisfy service delay requirements. Conversely, the BS broadcasts K number of different parity packets among the (3N−2K, K) RS-encoded packets from the respective sectors or cells at different times.

For example, when one cell includes three types of sectors (i.e., an α-type sector, a β-type sector and a γ-type sector), the α, βand γ-type sectors receive a systematic packet D in the first frame and receive a systematic packet E in the second frame. Likewise, the α, β and γ-type sectors receive the subsequent systematic packets F and G in the third and fourth frames. At this point, the respective sectors transmit the systematic packets in the current frame, along with different parity packets for the previous frame. That is, in the first frame, the α-type sector transmits the (K+1)˜Nth parity packet for packets C that are transmitted in the previous frame, the β-type sector transmits the (N+1)˜(2N−K)th parity packets, and the γ-type sector transmits the (2N−K+1)˜(3N−2K)th parity packets. In other words, the α-type sector receives the systematic packet D and the (K+1)˜Nth parity packets C of the previous frame, the , β-type sector receives the systematic packet D and the (N+1)˜(2N−K)th parity packets B of the previous frame, and the γ-type sector receives the systematic packet D and the (2N−K+1)˜(3N−2K)th parity packets A of the previous frame.

In the second frame, the α-type sector receives the systematic packet E and the (K+1)˜Nth parity packets D of the previous frame, the β-type sector receives the systematic packet E and the (N+1)˜(2N−K)th parity packets C of the previous frame, and the γ-type sector receives the systematic packet E and the (2N−K+1)˜(3N−2K)th parity packets B of the previous frame.

If an information block cannot be recovered from the systematic packet D received in the first frame, a UE receiving a service from the α-type sector attempts to recover the information block using the (K+1)˜Nth parity packets D that are transmitted along with the systematic packet E in the second packet. Also, if the information block cannot be recovered from the parity packets D received in the second frame, the UE performs an autonomous handover from the α-type sector to the β-type sector and receives the (N+1)˜(2N−K)th parity packets D from the β-type sector in the third frame. In addition, if the information block cannot be recovered from the parity packets D received from the β-type sector, the UE performs an autonomous handover from the β-type sector to the γ-type sector and receives the (2N−K+1)˜(3N−2K)th parity packets D from the γ-type sector in the fourth frame. Moreover, if the information block cannot be recovered for all the handovers, the UE may discard the corresponding packet.

While the UE of the first and second embodiments repeatedly receives the same parity packets by the autonomous handovers, the UE of the third embodiment receives different parity packets by the autonomous handovers, causing a reduction in the error rate of the information block.

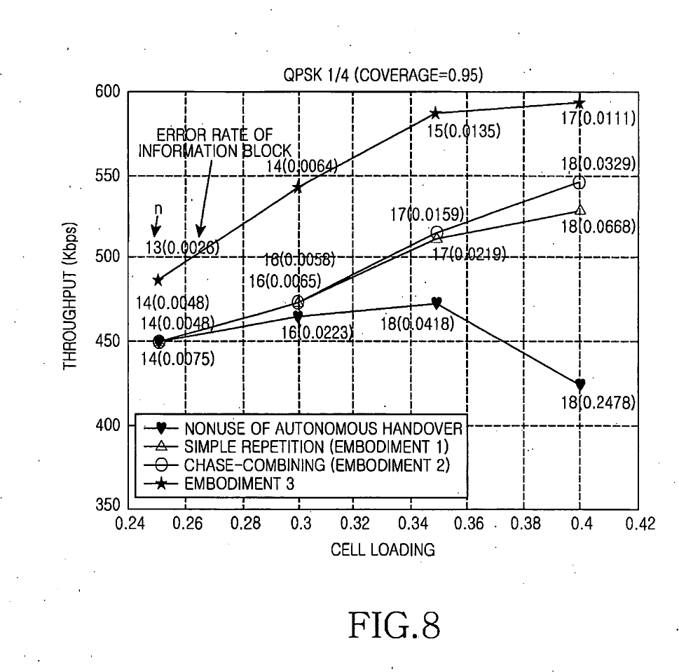

FIG. 8 is a graph illustrating the simulation results that compare the cell throughput of the conventional system, which does not use an autonomous handover, with the cell throughputs of the systems according to the first, second and third embodiments of the present invention. As described above, the system of the first embodiment repeatedly receives the parity packets by a repetition scheme. The system according to the second embodiment performs the chase-combining operation on the repeatedly-received parity packets.

Referring to FIG. 8, the simulation results show the cell throughputs depending on the cell loading of users in 95% of a cell coverage when a QPSK ⅛ scheme is used and a unicast connection is used to provide a multicast/broadcast service. When compared to the conventional system, the systems according to the first and second embodiments enhance the cell throughput by about 10% and the system according to the third embodiment enhances the cell throughput by about 25%. In addition, when the cell loading is large, the system of the third embodiment satisfies a target error rate of 0.01.

As described above, all cells of the wireless system according to the present invention simultaneously attempt to perform the initial transmission. The retransmission packets are transmitted from the respective cells at different times. When an error occurs in the packet received from the current cell, the UE in the cell boundary region performs an autonomous handover to another cell without transmission of uplink signals to receive more retransmission packets. Accordingly, the UEs in the cell boundary region can have more opportunities to receive retransmission packets using the same amount of radio resources. Therefore, it is possible to enhance the link-level performance of a multicast service for users in the cell boundary region. Also, it is possible to increase the outer coding rate or the MCS level for transmission of multicast packets. Consequently, it is possible to enhance the total cell throughput.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for enhancing the link performance of user equipments (UEs) in a wireless system, the method comprising the steps of:
recovering, when data is received in an Nth frame, the data by use of systematic packets of the data;
receiving, when the data is not recovered a first time, parity packets of the data in an (N+1)th frame and recovering the data by use of the received parity packets; and
receiving when the data is not recovered a second time, parity packets of the data from a neighboring cell or sector by performance of an autonomous handover and recovering the data by use of the parity packets received from the neighboring cell or sector.

2. The method of claim 1, further comprising chase-combining the parity packets received by the performance of the autonomous handover.

3. A method for enhancing a link performance of a base station (BS) in a wireless system, the method comprising the steps of:
generating, when there is data to be transmitted at a current frame, systematic blocks and parity blocks by use of an outer coding scheme and buffering the generated parity blocks for a time period; and
transmitting, by the BS, the generated systematic blocks and a parity block of previous data that is created in a previous frame and buffered for a previous time period.

4. The method of claim 3, wherein the outer coding scheme is a Reed-Solomon (RS) coding scheme.

5. The method of claim 3, wherein the transmission of the parity block from the BS is performed at a time that is different from a time when a transmission of a parity block in a BS of a neighboring cell or sector is performed.

6. The method of claim 3, wherein the parity block is different from a parity block in a BS of a neighboring cell or sector.

7. A transmitter for enhancing the link performance of a base station (BS) in a wireless system, the transmitter comprising:
an outer encoder for encoding data by an outer coding scheme to output the resulting encoded blocks including systematic blocks and parity blocks;
a parity block transmission controller for controlling times of transmission of the parity blocks from BSs such that the parity blocks are transmitted from sectors or cells at different times; and
a parity block buffer for buffering the parity blocks from the outer encoder for a time period and outputting the buffered parity blocks under the control of the parity block transmission controller.

8. The transmitter of claim 7, further comprising an inner encoder for encoding the parity blocks from the parity block buffer and the systematic blocks from the outer encoder by an inner coding scheme to output the resulting encoded blocks.

9. The transmitter of claim 8, wherein the inner coding scheme is one of a turbo coding scheme and a convolutional coding scheme.

10. The transmitter of claim 7, wherein the outer coding scheme is a Reed-Solomon (RS) coding scheme.

11. A receiver for enhancing the link performance of user equipments (UEs) in a wireless system, the receiver comprising:
an outer decoder for decoding an input packet by an outer decoding scheme to output the resulting decoded packet;
an error detector for detecting whether the decoded packet has an error to output the error detection results;
a cell/sector selector for determining whether to perform an autonomous handover based on the error detection results; and
a handover controller for selectively performing the autonomous handover according to the determination results.

12. The receiver of claim 11, further comprising an inner decoder for decoding an input packet by an inner decoding scheme to output the resulting decoded packet to the outer decoder.

13. The receiver of claim 12, wherein the inner coding scheme is one of a turbo coding scheme and a convolutional coding scheme.
